(19) United States
(12) Patent Application Publication
(10) Pub. No.: US 2024/0083213 A1
(43) Pub. Date: Mar. 14, 2024

(54) Heat Pump System

(71) Applicant: Hydrohertz Limited, Nottingham (GB)

(72) Inventor: Martyn Talbot, Nottingham (GB)

(21) Appl. No.: 18/272,977

(22) PCT Filed: Jan. 19, 2022
(86) PCT No.: PCT/GB2022/000005

§ 371 Date: Jul. 18, 2023

(30) Foreign Application Priority Data
Jan. 20, 2021 (GB) 2100783.6
Sep. 15, 2021 (GB) 2113188.3

(51) Int. Cl. B60H 1/00; B60H 1/32; B60N 2/56

(52) U.S. Cl. CPC B60H 1/00285; B60H 1/00278; B60H 1/3228; B60N 2/5692

(57) ABSTRACT

A heat pump system for an electric vehicle has a battery, at least one seat, a cabin, and an air conditioner to adjust the temperature within the cabin. The heat pump system comprises: a refrigerant circulatory system for circulating a refrigerant between first and second heat exchange regions; a compressor arranged in the refrigerant flow path between the first and second heat exchange regions; and an expansion valve arranged in the refrigerant flow path between the first and second heat exchange regions. The first heat exchange region is positioned in thermal contact with the seat of the electric vehicle and is arranged to receive thermal energy from a passenger in the seat. The second heat exchange region is positioned in thermal contact with one of the battery and the air conditioner of the electric vehicle, and is arranged to provide thermal energy to the battery or the air conditioner.

The present invention relates to a heat pump system, and more particularly to a heat pump system for an electric vehicle.

Conventional vehicles having an internal combustion engine (ICE) typically recycle excess heat from their engines to provide warm air to heat the vehicle interior via a heater, ie to warm a driver and any passenger(s). However, the drive components of an electric vehicle don't always produce enough waste heat to sufficiently heat the vehicle interior.

As a result, the heaters in electric vehicles have instead, at least historically, been electric heaters that draw power from the same rechargeable battery as the vehicle's electrical motor. This arrangement means that every time the heater is utilised, the vehicle's driving range is reduced, which is undesirable.

More recently, to overcome this problem, electric vehicles have utilised heat pump systems, or even reversible heat pump systems, which work much more efficiently. Heat pump systems work by transferring thermal energy from one place to another via a refrigerant circulatory system, but importantly, generate additional thermal energy via compression.

Thermal energy is absorbed from a first location, using a first heat exchanger such as a coil, known in the field as an evaporator. The absorption of thermal energy heats the refrigerant, causing the refrigerant liquid to evaporate and turn into gas. This gas is forced through a compressor, increasing the pressure of the gas, and in turn increasing the temperature of the gas. This generated heat is then transferred to a second location using a second heat exchanger, known in the field as a condenser, which can provide heat to the vehicle.

In this way, using a reversible heat pump system, during the winter heat can be transferred into the interior of the vehicle, and during the summer heat can be transferred away from the interior of the vehicle.

In the prior art, it is known that a heat exchanger can be positioned externally of the vehicle, ie to utilise thermal energy within the ambient environment, or adjacent to the vehicle's power components to utilise any wasted heat. In particular, the heat exchanger may be positioned adjacent to the vehicle's battery, enabling the temperature of the battery to be managed. This allows any excess heat to be transferred from the battery to the interior of the vehicle, but also allows the battery to be heated, when necessary, eg to bring it to the optimum charging temperature.

Recycling and maximising any ambient heat in this way reduces the need to draw energy from the vehicle's battery, whilst maintaining a comfortable internal environment for the driver and passengers.

However, whilst the driving range of electric vehicles remains limited (typically 150-250 miles per full charge), it is desirable to minimise the amount of energy required from the battery for anything other than powering the motor as much as possible.

In this respect, there has now been devised an improved heat pump system, which overcomes or substantially mitigates the abovementioned and/or other disadvantages associated with the prior art.

According to a first aspect of the invention, there is provided a heat pump system for an electric vehicle, the electric vehicle having a battery, at least one seat, a cabin, and an air conditioner arranged to adjust the temperature within the cabin, the heat pump system comprising: a refrigerant circulatory system for circulating a refrigerant between at least first and second heat exchange regions; a compressor arranged in the refrigerant flow path between the first and second heat exchange regions; and an expansion valve arranged in the refrigerant flow path between the first and second heat exchange regions; wherein the first heat exchange region is positioned in thermal contact with the at least one seat of the electric vehicle, and is arranged to receive thermal energy from a passenger sat in the at least one seat in use; and wherein the second heat transfer region is positioned in thermal contact with one of the battery and the air conditioner of the electric vehicle, and is arranged to provide thermal energy to the battery or the air conditioner in use.

According to a second aspect of the invention, there is provided a method of providing a heat pump system, the method comprising: installing the heat pump system in an electric vehicle, the electric vehicle having a battery, at least one seat, a cabin, and an air conditioner arranged to adjust the temperature within the cabin, the method further comprising the steps of: providing a refrigerant circulatory system for circulating a refrigerant between at least first and second heat exchange regions; arranging a compressor in the refrigerant flow path between the first and second heat exchange regions; arranging an expansion valve in the refrigerant flow path between the first and second heat exchange regions; positioning the first heat exchange region in thermal contact with the at least one seat of the electric vehicle, such that the first heat exchange region receives thermal energy from a passenger sat in the at least one seat in use; and positioning the second heat transfer region in thermal contact with one of the battery and the air conditioner of the electric vehicle, such that the second heat exchange region provides thermal energy to the battery or the air conditioner in use.

The heat pump system according to these aspects of the invention may be advantageous in that it utilises the readily available thermal energy provided by a driver of the electric vehicle to heat the cabin and/or the battery of the vehicle, which provides a substantially greater amount of energy than previous heat pump systems known in the art, and reduces the need to use energy from the battery itself.

Indeed, the applicant has discovered that by implementing the above system, the battery can be heated more efficiently, and up to a temperature of 60 degrees Celsius, which enables most electric vehicle batteries to be charged to over 80% of full charge in just ten minutes.

The refrigerant circulatory system may define a flow path in which refrigerant is delivered from the first heat exchange region to the second heat exchange region via the compressor, and the refrigerant is delivered from the second heat exchange region to the first heat exchange region via the expansion valve.

The system may further comprise a third heat exchange region positioned in thermal contact with the other one of the battery and the air conditioner of the electric vehicle. The third exchange region may be arranged to provide thermal energy to the other of the battery or the air conditioner in use. The refrigerant circulatory system may circulate the refrigerant between the first, second and third heat exchange regions.

The compressor may be arranged in the refrigerant flow path between the first and third heat exchange regions. The expansion valve may be arranged in the refrigerant flow path between first and third heat exchange regions.

The refrigerant circulatory system may define a flow path in which refrigerant is delivered from the first heat exchange region to the second and/or the third heat exchange region via the compressor, and the refrigerant is delivered from the second and/or the third heat exchange region to the first heat exchange region via the expansion valve.

The system may further comprise a first valve arrangement configured to control the flow of refrigerant to the second heat exchange region, and/or a second valve arrangement configured to control the flow of refrigerant to the third heat exchange region. The first and second valve arrangements may be controlled independently.

The first heat exchange region may be configured to function as an evaporator. That is, the first heat exchange region may be configured to transfer thermal energy to refrigerant held therein or passing therethrough. The second heat exchange region and/or the third heat exchange region may be configured to function as a condenser. That is, the second heat exchange region and/or the third heat exchange region may be configured to transfer thermal energy from refrigerant held therein or passing therethrough.

The second heat exchange region and/or the third heat exchange region may comprise a thermal energy store. This may be advantageous in that it enables energy to be stored in advance, so that energy can be provided to heat the battery or the vehicle cabin on demand. The refrigerant circulatory system may define a flow path in which refrigerant is delivered from the first heat exchange region to the thermal energy store of the second and/or the third heat exchange region via the compressor.

The system may further comprise a first filling valve arrangement configured to control the flow of refrigerant to the thermal energy store of the second heat exchange region, and/or a second filling valve arrangement configured to control the flow of refrigerant to the thermal energy store of the third heat exchange region. The first and second filling valve arrangements may be controlled independently.

The heat exchange region positioned in thermal contact with the air conditioner of the electric vehicle may be positioned in or on the base of the vehicle cabin. For example, this heat exchange region may be installed in the chassis or flooring of the vehicle. This may be advantageous in that it enables the front air intake grills that are typically present in electric vehicles to be removed. This in turn reduces the vehicle's drag in use. The air conditioner may be configured to provide hot and/or cold air to the vehicle cabin, ie the air conditioner may have dual functionality as a heater and a cooler.

The refrigerant circulated by the refrigerant circulatory system may be any conventional refrigerant such as a fluorinated refrigerant, eg a hydrofluorocarbon. However, most preferably the refrigerant is carbon dioxide, since it has a much lower global warming potential.

Preferably, the passenger from which the first heat exchange region receives thermal energy in use is a driver of the vehicle. However, where the electric vehicle comprises more than one seat, the heat pump system may be provided with additional heat exchange regions positioned to be in thermal contact with those seats, such that the additional heat exchange region(s) receive thermal energy from a passenger sat in those seats in use.

According to a further aspect of the invention, there is provided an electric vehicle comprising the heat pump system described above.

According to a further aspect of the invention, there is provided a method of operating the heat pump system defined above in an electric vehicle, the method comprising: passing refrigerant over or through the first heat exchange region; delivering the refrigerant from the first heat exchange region to the compressor; compressing the refrigerant; delivering the compressed refrigerant from the compressor to the second heat exchange region; passing the refrigerant over or through the second heat exchange region; delivering the refrigerant from the second heat exchange region to the expansion valve; expanding the refrigerant; and delivering the expanded refrigerant from the expansion valve to the first heat exchange region.

The method may further comprise the steps of: delivering the compressed refrigerant from the compressor to the third heat exchange region; passing the refrigerant over or through the third heat exchange region; and delivering the refrigerant from the third heat exchange region to the expansion valve.

The method may further comprise the step of: controlling the flow of the refrigerant from the first heat exchange region to the second heat exchange region via a first valve arrangement and/or controlling the flow of the refrigerant from the first heat exchange region to the third heat exchange region via a second valve arrangement.

Described above is a first mode of operating the heat pump system. The heat pump system may also be operable in a second mode of operation, in which it is desirable to remove thermal energy from the battery and/or the vehicle cabin, ie via the air conditioner.

In order to operate in this second mode of operation, the system may further comprise a fourth heat exchange region positioned on the exterior or externally of the electric vehicle. The refrigerant circulatory system may circulate the refrigerant between the first, second, third and fourth heat exchange regions. The system may also comprise a third valve arrangement configured to control the flow of refrigerant to the first heat exchange region, and/or a fourth valve arrangement configured to control the flow of refrigerant to the fourth heat exchange region. The third and fourth valve arrangements may be operated independently of each other and/or independently of one or both of the first and second valve arrangements.

In this mode of operation, assuming the second heat exchange regions is in thermal contact with the battery, and the third heat exchange region is in contact with the air conditioner, the refrigerant circulatory system may define a flow path in which refrigerant is delivered from the first and/or the third heat exchange region to the second and/or the fourth heat exchange region via the compressor, and the refrigerant is delivered from the second and/or the fourth heat exchange region to the first and/or the third heat exchange region via the expansion valve.

This arrangement may be advantageous in that when it is desirable to cool the cabin of the vehicle, heat can be removed via the driver's seat and the air conditioner and transferred to the battery, where desirable, or to the exterior of the vehicle.

The system may therefore further comprise a reversing valve arranged to switch the heat pump system between the first mode of operation and the second mode of operation, eg by reversing the direction of flow of refrigerant through the refrigerant circulatory system.

The heat exchange regions described above may comprise conventional means of providing heat exchange. For example, the heat exchange regions may comprise a heat exchanger, such as a coil or a coiled tubing/pipe arrangement, through which the refrigerant passes. The heat exchanger may comprise a plurality of spaced apart portions of increased diameter or cross-section relative to the remainder of the exchanger. This may be advantageous in that it increases the surface area of the exchanger, thus increasing the transfer of thermal energy from the driver's body to the refrigerant passing therethrough.

Practicable embodiments of the invention will now be described, by way of example only, with reference to the accompanying drawings, of which:

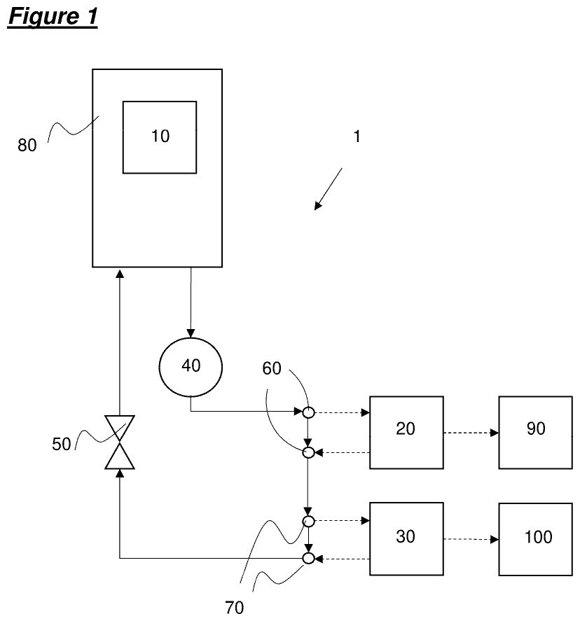

FIG. 1 is a schematic diagram of a heat pump system according to an embodiment of the invention; and

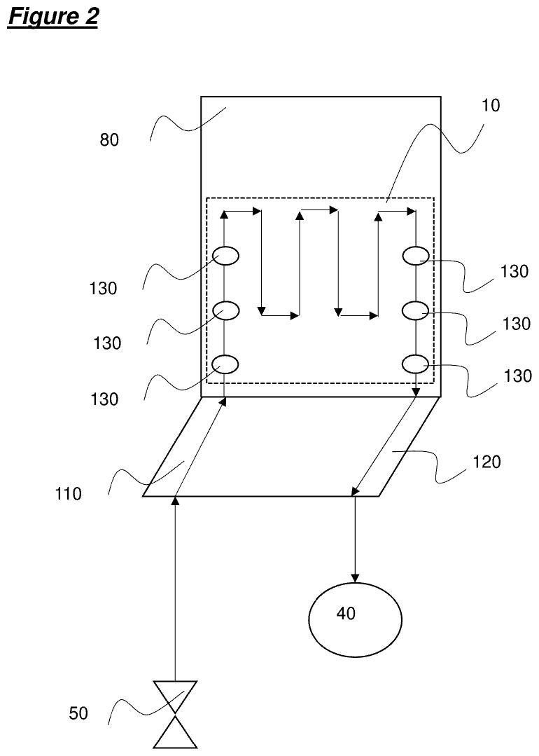

FIG. 2 is a schematic diagram of the first heat exchange region 10 of FIG. 1.

FIG. 1 illustrates a refrigerant circulatory system of a heat pump system 1 installed within an electric vehicle. The system 1 comprises a first heat exchange region 10, a second heat exchange region 20, a third heat exchange region 30, a compressor 40, an expansion valve 50, a first valve arrangement 60 and a second valve arrangement 70.

The first heat exchange region 10 comprises a coiled piping arrangement positioned within the driver's seat 80 of the electric vehicle. The second heat exchange region 20 comprises a coiled piping arrangement positioned in thermal contact with the battery 90 of the electric vehicle. The third heat exchange region comprises a coiled piping arrangement positioned in thermal contact with the electric vehicle's cabin heating system 100.

In use, when it is desirable to provide heat to the battery 90 and/or the vehicle's cabin heating system 100, the first heat exchange region 10 effectively acts as an evaporator and the second and third heat exchange regions 20, 30 effectively act as condensers.

A refrigerant is held within the piping arrangement of the system, and enters the first heat exchange region 10 as a low-temperature liquid. When a driver sits on the driver's seat 80, thermal energy is transferred from the driver to the refrigerant in the first heat exchange region 10. The transferred thermal energy heats the refrigerant, causing it to evaporate, and thus the refrigerant leaves the heat exchange region 10 as a low-temperature vapour.

The low-temperature vapour refrigerant passes from the heat exchange region into the compressor 40, which pressurises the low-temperature vapour refrigerant, increasing both the pressure and the temperature of the refrigerant.

The pressurised, heated vapour refrigerant passes from the compressor 40 to the second and/or third heat exchange regions 20, 30, which are controlled by their respective valve arrangements 60, 70. In the second and/or third heat exchange regions 20, 30, the pressurised, heated vapour refrigerant condenses, which transfers thermal energy to the battery 90 and/or the vehicle's cabin heating system 100, and the refrigerant leaves the second and/or third heat exchange regions 20, 30 as a high-temperature, high-pressure liquid refrigerant.

When it is desirable to provide heat to the battery 90, for example to optimise charging conditions, valve arrangement 60 is opened, so that the pressurised, heated vapour refrigerant can pass into the second heat exchange region 20 and transfer thermal energy to the battery 90. When it is desirable to prevent heat from reaching the battery 90, valve arrangement is closed, so that the pressurised, heated vapour refrigerant cannot pass into the second heat exchange region 20 and transfer thermal energy to the battery 90.

When it is desirable to provide heat to the cabin heater 100, valve arrangement 70 is opened, so that the pressurised, heated vapour refrigerant can pass into the third heat exchange region 30 and transfer thermal energy to the heater 100.

When it is desirable to prevent heat from entering the cabin heater 100, valve arrangement 70 is closed, so that the pressurised, heated vapour refrigerant cannot pass into the third heat exchange region 30 and transfer thermal energy to the heater 100. The heater 100 may consist of either underfloor heating, provided by matting installed in the floor of the vehicle, or a conventional heater arrangement.

The valve arrangements 60, 70 may be simultaneously opened so that the pressurised, heated vapour refrigerant can pass into both the second and third heat exchange regions 20, 30 at the same time, if desired. Alternatively, the valve arrangements 60, 70 may be simultaneously closed so that the pressurised, heated vapour refrigerant cannot pass into either of the second and third heat exchange regions 20, 30, if desired.

As the high-temperature, high-pressure liquid refrigerant leaves the condenser stages, the refrigerant is passed through the expansion valve 50. The expansion valve 50 allows the refrigerant to expand and decompress, which reduces its pressure and its temperature, so that the refrigerant can be recycled back into the first heat exchange region 10 and the cycle described can begin again.

Since there may be times when it is desirable to operate the system 1 in advance of requiring the provision of heat to the battery 90 or the vehicle cabin 100, the second and third heat exchange regions 20, 30 may further comprise means of storing thermal energy, ie so that the thermal energy can be later transferred to the battery 90 or the vehicle cabin 100, when desired. This may be implemented in any conventional manner, for example by providing a sealed insulated tank associated with each of the second and third heat exchange regions 20, 30. The insulated tank would store a heat transfer fluid, and in use, when desirable, thermal energy would be transferred from the refrigerant of the heat pump system to the heat transfer fluid, rather than directly to the second and/or third heat exchange regions 20, 30. The thermal energy would then be stored in the insulated tank, until it is desirable to transfer the energy to the second and/or third heat exchange regions 20, 30.

The transfer of thermal energy from the refrigerant of the heat pump system to the insulated tanks is controlled by respective filling valves, and the transfer of thermal energy from the insulated tanks to the second and third heat exchange regions 20, 30 is controlled by respective draining valves. A bleed valve is also utilised to prevent unwanted air from collecting in the tanks.

Where it is instead desirable to cool the cabin of the electric vehicle, eg via air conditioning, the heat pump system 1 may be operated in an alternative manner, in which the first heat exchange region 10 and/or the third heat exchange region effectively act as evaporators, and the second heat exchange region effectively acts as a condenser. This enables heat to be transferred from the driver's seat 80 and the vehicle cabin (via the heating system vents 100), to the battery 90. In this arrangement, the vehicle would typically also comprise a fourth heat exchange region external of the vehicle cabin (not illustrated), so that when it is not desirable to transfer the heat from the driver's seat 80 and the vehicle cabin to the battery 90, the heat can instead be dissipated externally of the vehicle.

For this reason, the system 1 further comprises a reversing valve (not shown), which is configured to reverse the direction of flow of the refrigerant in the system, and therefore switch the functionality of one or more of the heat exchange regions, ie between effectively acting as a condenser and effectively acting as an evaporator.

Each of the heat exchange regions may therefore have an associated valve arrangement, and the refrigerant circulatory system may therefore bypass any one or more of the heat exchange regions during operation, dependent on the desired heating/cooling functionality.

They system may also comprise a monitoring unit (not illustrated), which monitors the condition of the air within the cabin of the vehicle, and supply fresh air (ie from outside of the vehicle via a mechanical grill), should the air within the cabin be deemed to be unsatisfactory. The monitoring unit may monitor, for example, the air humidity, the amount of oxygen in the air, or the amount of carbon dioxide in the air.

FIG. 2 illustrates the arrangement of the first heat exchange region 10 within the driver's seat 80, and in particular the coiled or looped nature of the piping arrangement (illustrated by the arrows drawn within the heat exchange region 10).

The coiled piping arrangement of the first heat exchange region 10 comprises an inlet conduit 110 that receives decompressed, cooled liquid refrigerant from the expansion valve 50, and an outlet conduit 120 that delivers the gaseous refrigerant to the compressor 40. The inlet conduit 110 and outlet conduit 120 are built into the lower portion of the driver's seat 80, ie the portion that the driver sits on in use.

Between the inlet conduit 110 and outlet conduit 120, the heat exchange region 10 comprises a looped piping arrangement, which increases the surface area of the heat transfer region 10, thus increasing the transfer of thermal energy from the driver's body to the liquid refrigerant held in the piping in use. The piping is made of a thermally conductive material so that the driver's body heat can easily pass into the piping to heat the liquid refrigerant therein. The piping arrangement is built into the upper portion of the driver's seat 80, ie the portion that the driver's back rests on in use.

Positioned sporadically over the length of the piping arrangement are pods 130. The pods 130 are roughly spherically shaped and create bulges in the piping, which increase the surface area of the piping, thus increasing the transfer of thermal energy from the driver's body to the liquid refrigerant held in the piping in use.

1. A heat pump system for an electric vehicle, the electric vehicle having a battery, at least one seat, a cabin, and an air conditioner arranged to adjust a temperature within the cabin, the heat pump system comprising:
a refrigerant circulatory system for circulating a refrigerant between at least first and second heat exchange regions;
a compressor arranged in a refrigerant flow path between the first and second heat exchange regions; and
an expansion valve arranged in the refrigerant flow path between the first and second heat exchange regions,
wherein a first heat exchange region is positioned in thermal contact with the at least one seat of the electric vehicle, and is arranged to receive thermal energy from a passenger sat in the at least one seat in use, and
wherein a second heat exchange region is positioned in thermal contact with one of the battery and the air conditioner of the electric vehicle, and is arranged to provide thermal energy to the battery or the air conditioner in use.

2. The heat pump system according to claim 1, wherein the refrigerant circulatory system defines the refrigerant flow path in which refrigerant is delivered from the first heat exchange region to the second heat exchange region via the compressor, and the refrigerant is delivered from the second heat exchange region to the first heat exchange region via the expansion valve.

3. The heat pump system according to claim 1, further comprising a third heat exchange region positioned in thermal contact with the other one of the battery and the air conditioner of the electric vehicle, and arranged to provide thermal energy to the battery or the air conditioner.

4. The heat pump system according to claim 3, wherein the compressor is arranged in the refrigerant flow path between the first heat exchange region and the third heat exchange region.

5. The heat pump system according to claim 3, wherein the expansion valve is arranged in the refrigerant flow path between first and third heat exchange regions.

6. The heat pump system according to claim 3, wherein the refrigerant circulatory system defines the refrigerant flow path in which refrigerant is delivered from the first heat exchange region to the second and/or the third heat exchange region via the compressor, and the refrigerant is delivered from the second and/or the third heat exchange region to the first heat exchange region via the expansion valve.

7. The heat pump system according to claim 1, further comprising a first valve arrangement configured to control a flow of refrigerant to the second heat exchange region.

8. The heat pump system according to claim 7, further comprising a second valve arrangement configured to control a flow of refrigerant to a third heat exchange region.

9. The heat pump system according to claim 8, wherein the first valve arrangement and the second valve arrangement are controlled independently.

10. The heat pump system according to claim 1, wherein the first heat exchange region is configured to function as an evaporator.

11. The heat pump system according to claim 1, wherein one or both of the second heat exchange region is configured to function as a condenser and a third heat exchange region is configured to function as a condenser.

12. (canceled)

13. The heat pump system according to claim 1, wherein one or both of the second heat exchange region comprises a thermal energy store and a third heat exchange region comprises a thermal energy store.

14. (canceled)

15. The heat pump system according to claim 3, wherein the heat exchange region that is positioned in thermal contact with the air conditioner of the electric vehicle is positioned in or on a base of the cabin.

16. The heat pump system according to claim 1, wherein the refrigerant circulated by the refrigerant circulatory system is carbon dioxide.

17. The heat pump system of claim 1 configured for use in an electric vehicle.

18. A method of providing a heat pump system, the method comprising:
installing the heat pump system in an electric vehicle, the electric vehicle having a battery, at least one seat, a cabin, and an air conditioner arranged to adjust a temperature within the cabin, the method further comprising the steps of:
providing a refrigerant circulatory system for circulating a refrigerant between at least first and second heat exchange regions;
arranging a compressor in a refrigerant flow path between the first and second heat exchange regions;
arranging an expansion valve in the refrigerant flow path between the first and second heat exchange regions;
positioning a first heat exchange region in thermal contact with the at least one seat of the electric vehicle, such that the first heat exchange region receives thermal energy from a passenger sat in the at least one seat in use; and
positioning a second heat exchange region in thermal contact with one of the battery and the air conditioner of the electric vehicle, such that the second heat exchange region provides thermal energy to the battery or the air conditioner in use.

19. A method of operating the heat pump system of claim 1 in an electric vehicle, the method comprising:
passing refrigerant over or through the first heat exchange region;
delivering the refrigerant from the first heat exchange region to the compressor;
compressing the refrigerant;
delivering the compressed refrigerant from the compressor to the second heat exchange region;
passing the refrigerant over or through the second heat exchange region;
delivering the refrigerant from the second heat exchange region to the expansion valve;
expanding the refrigerant; and
delivering the expanded refrigerant from the expansion valve to the first heat exchange region.

20. The method of claim 19, further comprising the steps of:
delivering the compressed refrigerant from the compressor to a third heat exchange region;
passing the refrigerant over or through the third heat exchange region; and
delivering the refrigerant from the third heat exchange region to the expansion valve.

21. The method of claim 19, further comprising the step of:
controlling a flow of refrigerant to the second heat exchange region via a first valve arrangement and/or controlling the flow of refrigerant to a third heat exchange region via a second valve arrangement.

22. The heat pump system according to claim 1, wherein the second heat exchange region is positioned in thermal contact with the battery of the electric vehicle and is arranged to provide thermal energy to the battery in use.
